(19) United States
(12) Patent Application Publication
(10) Pub. No.: US 2025/0190248 A1
(43) Pub. Date: Jun. 12, 2025

(54) AUTOMATED CAPACITY MANAGEMENT FOR ASYNCHRONOUS TASK PROCESSORS

(71) Applicant: Zendesk, Inc., San Francisco, CA (US)

(72) Inventors: Jordan Hinkle, Madison, WI (US); Steven N. Bloch, Bothell, WA (US)

(73) Assignee: Zendesk, Inc., San Francisco, CA (US)

(21) Appl. No.: 18/536,484

(22) Filed: Dec. 12, 2023

(51) Int. Cl. G06F 9/48

(52) U.S. Cl. CPC G06F 9/4881

(57) ABSTRACT

A system and methods are provided for conserving computing resources during automated capacity management of worker entities for processing asynchronous computing tasks. Each new task is placed in one of multiple queues maintained by a queue data store, wherein each queue has a corresponding fleet of workers for processing the queue's tasks. The queue data store periodically yields status data that may include the total number of workers assigned to each queue, the number of workers that are currently processing tasks, a rate of change in queue sizes, etc. These data are used to calculate the busyness of each queue's workers, which may be the percentage of the queue's workers that are busy or idle or a sequence of rates of change in the queue size. Based on the busyness, one or more new workers may be spawned or one or more existing workers may be terminated.

### BACKGROUND

This disclosure relates to the fields of computer systems and capacity planning. More particularly, a system and methods are provided for automatically adjusting a population of worker processes for handling asynchronous tasks, based on conditions within the operating environment.

Traditional schemes for managing the capacity of automated worker processes depend upon the size or depth of a queue of unserviced tasks or jobs to be assigned to the workers. For example, additional worker processes might be instantiated after the queue accumulated a threshold number of unprocessed tasks. New resources may then be allocated on a constant basis until the queue was empty or the number of unserviced tasks diminished.

However, the size of a queue of unserviced tasks is a lagging indicator, meaning that by the time the depth of the queue reaches a particular threshold, tasks may already be delayed and/or a user's workload may already be negatively impacted, even before capacity for handling the tasks begins ramping up. Further, because the number of worker processes required to service the waiting tasks is unknown, too many may be instantiated, which would waste their associated resources (e.g., memory, CPU cycles, communication bandwidth).

### SUMMARY

In some embodiments, systems and methods are provided for automatically managing a population of worker entities (e.g., processes, threads) that handle asynchronous tasks from any number of sources (e.g., users, customers, other processes). In these embodiments, the population is proactively increased (or decreased) based on the busyness of the worker entities (or simply “workers”).

In some implementations, busyness may comprise a percentage of workers that are currently processing tasks (e.g., a “busy percentage”); in other implementations it may comprise a percentage of workers that are idle (e.g., an “idle percentage”); in yet other implementations it may comprise rates of change to a queue's size, which reflects the rate at which new tasks are queued. When a busyness measurement reaches or crosses a threshold value, one or more workers may be added to or removed from the environment.

The operating environment may feature multiple queues for receiving new (unprocessed) tasks, which may be differentiated based on characteristics such as priority, required type of processing, task originator, complexity, an application or service through which the task was received or with which the task is associated, etc. In some implementations, a separate pool or fleet of worker entities may be maintained and used to service each queue's tasks.

Busyness may be determined on a per-queue basis and/or across multiple queues, with worker populations being adjusted accordingly. For example, when different pools or fleets of worker entities are maintained for each queue, the populations of pools associated with different queues may independently of each other. Because extraneous workers are terminated and new ones added in an intelligent manner, system resources are conserved in comparison to traditional methods of capacity management.

### DESCRIPTION OF THE FIGURES

FIG. 1 is a block diagram of an illustrative computing environment in which a population of worker entities for processing asynchronous tasks is managed automatically, according to some embodiments.

FIG. 2 is a flow chart illustrating a method of managing a population of worker entities for processing asynchronous tasks, according to some embodiments.

### DETAILED DESCRIPTION

The following description is presented to enable any person skilled in the art to make and use the disclosed embodiments, and is provided in the context of one or more practical applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, methods and systems are provided for automatically maintaining and managing a population of worker entities that process asynchronous computing tasks. The system may expose one or more applications or services to users, customers, and/or other entities, or may operate in conjunction with a system that offers such applications and/or services. Use of the applications and service may entail the generation of requests for stored data, updates to the stored data, requests for information or user assistance, etc. The worker entities (which may also or instead be referred to as workers, task workers, task processors, worker processes, and so on) service the tasks by performing the necessary processing depending on task parameters and reporting results when and as appropriate.

In these embodiments, statuses of the worker entities are periodically or regularly examined to determine numbers and/or percentages of workers that are busy or idle. Instead of waiting until task execution slows and/or a task queue grows to contain some number of unprocessed tasks before ramping up the worker population, when a predetermined threshold percentage of existing workers is busy, one or more additional workers may be added to the population. Alternatively, when a predetermined threshold percentage of workers is idle, one or more existing workers may be removed from the population. The percentage of busy or idle workers may be referred to as the busyness of a pool or fleet of worker entities.

In implementations in which multiple task queues exist for receiving new tasks, and different sets of workers tend different queues, each set of workers may be monitored independently or in parallel. Thus, in these implementations, different pools or fleets of workers may be adjusted independently of each other, based on their busyness.

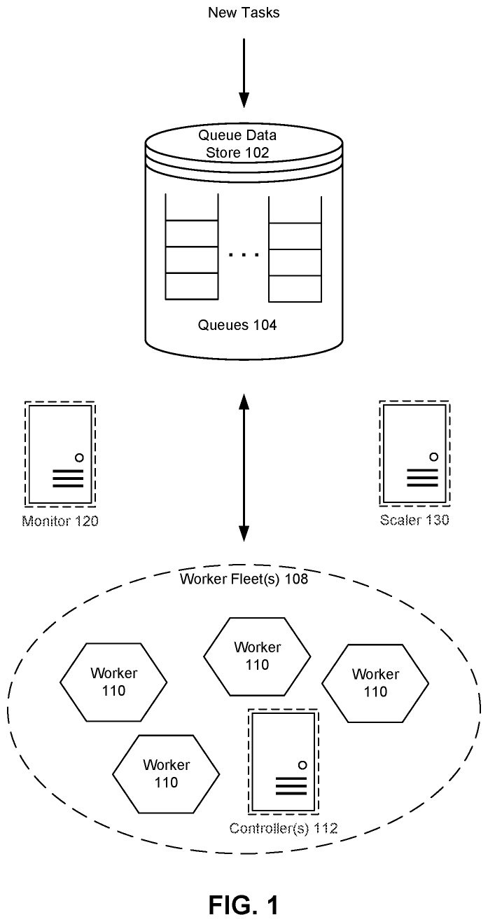

FIG. 1 is a block diagram of an illustrative computing environment in which worker entities for processing asynchronous tasks are managed automatically, according to some embodiments.

In these embodiments, new (unprocessed) tasks or jobs are received at queue data store 102 and placed in a corresponding queue 104. A user of an application or service may, for example, manipulate the application or service via an application programming interface (API) to generate a task (or cause generation of a task) as part of accomplishing some goal (e.g., to conduct or change a transaction, to request or supply data, to send a communication). The API or queue data store may determine one or more characteristics of the task (e.g., type, associated application or service, priority, originator) and enqueue it appropriately.

Worker fleet(s) 108 comprise any number of (e.g., one or more) workers 110 for servicing queues 104 and executing or processing the queued tasks. Each worker may be assigned to a specific queue, in which case it only processes tasks placed in that queue. Alternatively, a worker may be able to service tasks from multiple queues. As already indicated, the system may comprise a distinct fleet for each queue 104. A worker fleet may alternatively be termed a worker pool.

Worker fleet(s) 108 include one or more controllers 112, such as one controller per fleet. Controller 112 is responsible for increasing or decreasing the size of a fleet in response to instructions from scaler 130, as described below. More specifically, controller 112 causes new worker entities to be spawned or instantiated as needed, and similarly terminates existing entities when the worker population is too high.

Queue data store 102 includes one or more computer systems or processors that execute logic to enqueue new tasks, update tasks as necessary (e.g., to identify the queues they are assigned to, to note when workers are assigned to them), and perform other operations. For example, when a new worker 110 is added to a worker fleet 108, it registers with the queue data store to identify itself (e.g., with a unique worker ID) and the queue it will service. Thus, queue data store 102 maintains a record of all active workers (i.e., workers that have registered with the queue data store and have not been terminated) and their assigned queues.

Tasks may remain in the queue data store until their processing is complete. Because queue data store 102 knows of all active workers and which workers are currently processing tasks, it can determine each active worker's current status (i.e., busy or idle) at any time. The queue data store may be replicated, partitioned, sharded, or otherwise distributed, or may be implemented as a solitary entity. The quantity of queues 104 may vary from one embodiment to another; in some embodiments there are tens or dozens of queues.

Worker monitor 120 monitors worker fleet(s) 108 and/or queues 104 to determine statuses of existing workers, such as whether they are idle or busy, which queue (or queues) each worker is assigned to, and/or other operating conditions. In some implementations, monitor 120 polls queue data store 102 on a periodic basis (e.g., every 10 seconds) to obtain data such as the number of workers registered with the queue data store, which queue(s) each registered worker is assigned to, and which (or how many) workers are currently processing a task. Monitor 120 can then calculate a current busyness of the worker fleets as the percentage of existing workers that are busy (or idle), on an overall and/or a per-queue/fleet basis.

Some or all metrics collected and/or calculated by monitor 120, particularly the current busyness, may be published via a publish/subscribe framework, may be stored in a database or other local data repository (not shown in FIG. 1), or may be placed in some other location for access by other entities (e.g., scaler 130). Multiple busyness values (and/or other metrics) may be retained for historical purposes, for averaging or combining a series of values, and/or for other purposes.

Scaler 130 automatically scales worker fleet(s) 108 (i.e., to add or remove workers 110) as described herein, based on busyness and/or other factors. In some implementations, when scaler 130 determines that a new worker is needed (or that one can be retired), it signals worker fleet(s) 108 (e.g., controller 112), which creates the new worker (or terminates an idle worker). When the new worker is instantiated or otherwise comes online, it registers with queue data store 102 and identifies the queue(s) it will service.

In different embodiments, target busyness thresholds (e.g., a threshold percentage of existing workers that are busy) may be set differently. For example, scaler 130 may expose an interface through which an operator or system manager can set or change a value. Using this interface, the same or different thresholds may be set for different queues 104. Thresholds may be stored in or copied to scaler 130, or may be maintained elsewhere but accessed by the scaler as needed. For example, scaler 130 may retrieve or examine the target worker busyness threshold(s) on a periodic basis (e.g., every 30 seconds) to ensure it is using current and correct values.

In some implementations, a single busyness threshold (e.g., 70%) serves as the trigger both for adding and for removing workers. In these implementations, each time the current busyness is examined and found to exceed the threshold for a given queue 104, one or more workers may be added and assigned to the queue. Conversely, each time the current busyness is examined and found to fall below the same threshold, one or more workers assigned to the queue may be terminated. Comparisons of the current busyness to the target threshold, and initiation of any necessary corrections, may occur on a cyclical basis having any suitable periodicity (e.g., 1 second, 5 seconds, 10 seconds).

Each cycle that busyness is above the threshold for a queue, another worker may be added until it falls below the threshold (e.g., or a maximum number of workers is reached). Similarly, when workers are being removed, each cycle may cause termination of another worker until (a) busyness again reaches the threshold or (b) the number of workers assigned to the queue falls to a minimum value.

In some implementations, for each cycle, scaler 130 examines a recent period of activity (e.g., five minutes), meaning that it assembles all busyness values produced by monitor 120 during that period. It may average the values, find the median value, or adopt some other value representative of the period of activity. Comparing that value to the target threshold for each queue causes the scaler to initiate any necessary adjustments by instructing worker fleet(s) 108 accordingly.

In other embodiments, different busyness thresholds may be employed for adding workers and for removing workers. Also, or instead, different thresholds may be applied for different queues. For example, a single busyness threshold set for a queue that primarily (or only) receives relatively complex tasks, or tasks that require more time to process (e.g., on average), may be lower than the single threshold for a queue that generally receives jobs that can be processed quickly.

Different numbers of workers 110 may be assigned to and registered with different queues 104; in other words, different worker fleets may have different populations. In some embodiments, when the system begins operation, each queue is initially assigned the same number (e.g., 20, 30) of worker management entities that primarily function to spawn actual worker entities (e.g., processes, threads, or other entities that process tasks). These worker management entities will spawn some minimum number of initial workers for their queues as system operations commence. During operation of the system, the worker management entities spawn additional workers and/or terminate existing workers upon request (e.g., from scaler 130). Because a given queue 104 may handle hundreds of thousands of tasks in a typical day, with bursts of activity in which ten thousand tasks or more are queued simultaneously, the size of any or all worker fleets may fluctuate widely over time.

Although depicted as separate entities in the environment depicted in FIG. 1, some or all of queue data store 102, worker fleet(s) 108, monitor 120, and scaler 130 may be collocated. In other words, some or all of the entities may comprise or be hosted by the same physical or virtual computer systems and share the same physical resources. Yet further, any of these entities may be duplicated as necessary (e.g., within a computing cluster or network environment) to accommodate the demands within a particular computing environment.

In some embodiments, in addition to (or instead of) using current busy or idle percentages, a rate of change in the size of a queue may be used to measure busyness. Specifically, in these embodiments, the number of tasks added to a queue in a unit of time (e.g., one second) may be measured on a periodic basis (e.g., every second, every five seconds). When a sequence of increases is observed in the rate at which a given queue increases in size (e.g., increases in three consecutive periods), the population of the given queue's worker fleet may be increased. Conversely, when a sequence of decreases is observed, the population of the fleet may be decreased.

In these embodiments, the queue data store will monitor the arrival of tasks into each queue to measure the number of tasks added to each queue during each unit of time. The data store may report the collected data to a monitor module or the monitor module may poll or query the data store for the information, and the monitor module may publish the information as it does with worker busyness values. A scaler module will consume the rate of change data and scale worker populations as warranted.

Thus, in different embodiments, different means or values may be used to represent the busyness of a task queue or a task queue's corresponding fleet of workers.

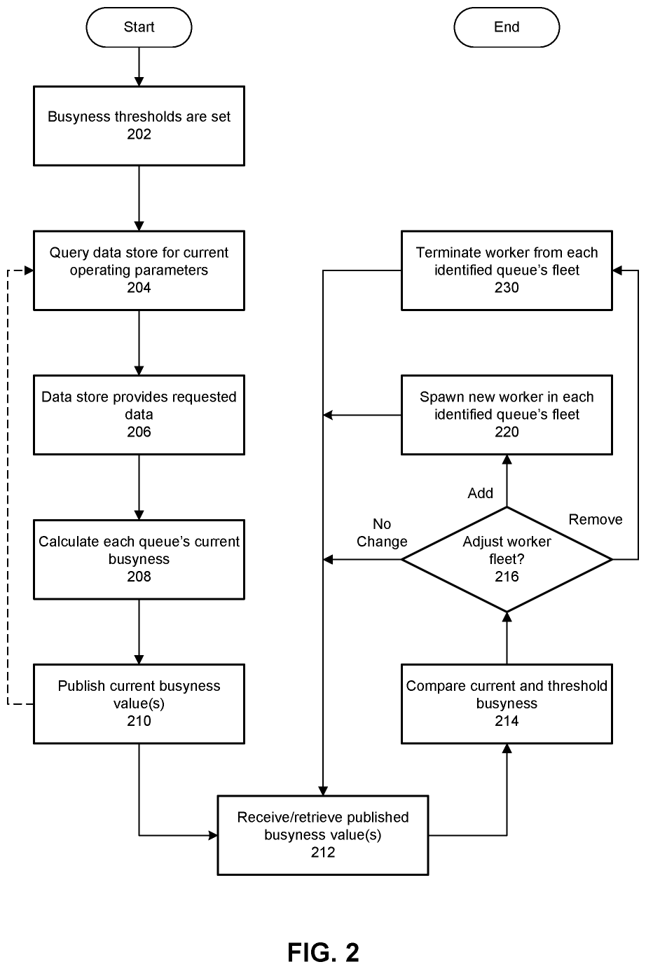

FIG. 2 is a flow chart illustrating a method of automated capacity management of worker entities for processing asynchronous tasks, according to some embodiments. In some implementations, one or more of the operations may be omitted, repeated, and/or performed in a different order. Accordingly, the specific arrangement of steps shown in FIG. 2 should not be construed as limiting the scope of the embodiments.

In these embodiments, new (unprocessed) tasks are received on a periodic, regular, or constant basis. Depending upon factors such as the originator of a task (e.g., a user, another task), an application or service through which the task was initiated, the priority and/or complexity of the task, and/or other information, each one is placed in an appropriate queue within a data store.

Also, in these embodiments, worker entities (e.g., processes, threads) that are associated with specific queues are assigned to the tasks, execute their payloads or initiate the processing necessary to satisfy the task, and may return a result. These activities (i.e., receiving new tasks and processing waiting tasks) continue in parallel throughout the method depicted in FIG. 2.

In operation 202, an operator, system manager, developer, or other authority sets busyness thresholds for the task queues and their corresponding worker fleets. As described above, the busyness of a queue or its associated worker fleet may be calculated differently in different implementations. Different queues may have the same or different thresholds, and a given queue may have one or more multiple thresholds for determining when to increase the size of its fleet and when to decrease the size of its fleet.

In operation 204, a monitor module (e.g., monitor 120 of FIG. 1) queries or polls the data store(s) containing the task queues. The monitor requests information such as the number of task queues, the number of workers registered with the data store, the number of workers assigned to each queue, the status (busy or idle) of each registered worker (or, alternatively, the number of tasks currently being processed within each queue), and the rate of change of the size of the queue. A worker is considered busy unless it is idle (i.e., not processing a job). Operation 204 may be repeated on a periodic basis, such as every ten seconds, which may vary from one embodiment to another.

In operation 206, in response to the query or poll, the data store assembles the requested information. Because all active workers register with the data store when they are created, and identify which queue(s) they will service, the data store can quickly determine how many workers are assigned to each queue (and the overall number of workers). Furthermore, the data store may scan all queued tasks and, while scanning, note which tasks have been assigned to workers, and may identify each assigned worker. The data store then reports this information to the monitor module.

In operation 208, the monitor module calculates the current busyness for each task queue and/or overall. Thus, if busyness is defined as the busy percentage (or worker saturation), it will divide the number of tasks in a queue that are currently being processed by the total number of workers assigned to the queue (i.e., the size of the queue's fleet).

In operation 210, the monitor module publishes its calculations for use by other entities, as described immediately below, stores them, and/or otherwise makes them available. Calculations may be retained for any suitable length of time. It should be noted that operations 204-210 repeat cyclically, independently of the remainder of the illustrated method.

In operation 212, a scaler module (e.g., scaler 130 of FIG. 1) retrieves the data produced by the monitor module, with the same or different periodicity with which it is produced.

In operation 214, for each task queue, the scaler module compares the queue's currently busyness with one or more target thresholds (e.g., the thresholds set in operation 202). For example, a queue may have a single threshold, as described above, or may have upper and lower thresholds. In these cases, whenever the queue's busyness is above the upper threshold, one or more new workers may be created and assigned to the queue. Conversely, when the busyness is below the lower threshold, one or more existing workers assigned to the queue may be terminated. As already mentioned, different queues may have different thresholds.

In operation 216, a determination is made (based on the comparisons in operation 214) whether workers should be added to or removed from any queue(s). If one or more workers are to be added to any queue's fleet of workers, the method advances to operation 220; if one or more workers are to be removed from any queue's workforce, the method also or instead advances to operation 230. Otherwise, if no changes are needed, the method returns to operation 212.

In operation 220, because the current busyness measures of one or more queues identified by the scaler module exceed applicable thresholds, a new worker entity is spawned for each identified queue (e.g., by controller 112 of FIG. 1). Each new worker immediately registers with the data store, identifies its assigned queue, and begins servicing it. The method then returns to operation 212.

In operation 230, because relatively few workers are busy for one or more queues identified by the scaler module, one worker assigned to each identified queue is terminated (e.g., by controller 112). The method then returns to operation 212.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A system for managing automated worker entities, comprising:
a data store comprising multiple queues for queueing tasks;
for each of the multiple queues, a corresponding pool of worker entities for executing the queued tasks;
a monitor module executing logic to:
periodically obtain statuses of the worker entities; and
calculate a current busyness of each queue's pool of worker entities based on the obtained statuses; and
means for adjusting a size of a first pool of worker entities corresponding to a first queue based on the busyness of the first pool of worker entities.

2. The method of claim 1, wherein the means for adjusting comprises:
a scaling module that compares the current busyness of the first pool of worker entities to a target threshold; and
a worker controller that implements the adjustment to the size of the first queue's pool of worker entities.

3. The method of claim 1, wherein:
each worker entity is assigned to one of the multiple queues; and
the statuses of the worker entities comprise, for each queue:
a total number of worker entities assigned to the queue; and
a number of worker entities assigned to the queue that are currently processing tasks from the queue.

4. The method of claim 1, wherein the busyness of the first pool of worker entities identifies a percentage of worker entities within the first pool that are processing tasks from the queue.

5. The method of claim 1, wherein:
the queue data store executes logic to periodically measure, for each queue, a rate of addition of new tasks to the queue; and
the busyness of the first pool of worker entities reflects a sequence of measured rates of addition of new tasks to the first queue.

6. The method of claim 1, wherein the busyness of the first pool of worker entities does not depend upon a number of tasks in the queue.

7. A method of managing automated worker entities, the method comprising:
maintaining multiple queues for storing new tasks;
for each queue, maintaining a corresponding pool of worker entities for processing tasks in the queue;
setting one or more target busyness thresholds for the pools of worker entities;
for each queue, determining a current busyness of the corresponding pool of worker entities;
when the current busyness is greater than a first busyness threshold, adding one or more new worker entities to the corresponding pool; and
when the current busyness is less than a second busyness threshold, terminating one or more worker entities of the corresponding pool.

8. The method of claim 7, wherein said determining a current busyness comprises:
periodically determining a percentage of worker entities assigned to the queue that are currently processing tasks; and
combining the determined percentages over multiple time periods.

9. The method of claim 7, wherein said determining a current busyness comprises:
periodically determining a percentage of worker entities assigned to the queue that are idle; and
combining the determined percentages over multiple time periods.

10. The method of claim 7, wherein said determining a current busyness comprises:
periodically determining a rate of change in a size of the queue; and
identifying a sequence of successive increases in the size of the queue over multiple time periods.

11. The method of claim 7, wherein said determining a current busyness comprises:
periodically determining a rate of change in a size of the queue; and
identifying a sequence of successive decreases in the size of the queue over multiple time periods.

12. The method of claim 7, further comprising periodically obtaining, for each of the multiple queues:
a number of worker entities currently assigned to the queue; and
a number of tasks within the queue that are currently being processed by the assigned worker entities.

13. The method of claim 7, wherein the first busyness threshold and the second busyness threshold are the same.

14. A non-transitory computer-readable medium storing instructions that, when executed by a computer system, cause the computer system to perform a method of managing automated worker entities, the method comprising:
maintaining multiple queues for storing new tasks;
for each queue, maintaining a corresponding pool of worker entities for processing tasks in the queue;
setting one or more target busyness thresholds for the pools of worker entities;
for each queue, determining a current busyness of the corresponding pool of worker entities;
when the current busyness is greater than a first busyness threshold, adding one or more new worker entities to the corresponding pool; and
when the current busyness is less than a second busyness threshold, terminating one or more worker entities of the corresponding pool.

15. The non-transitory computer-readable medium of claim 14, wherein said determining a current busyness comprises:
periodically determining a percentage of worker entities assigned to the queue that are currently processing tasks; and
combining the determined percentages over multiple time periods.

16. The non-transitory computer-readable medium of claim 14, wherein said determining a current busyness comprises:
periodically determining a percentage of worker entities assigned to the queue that are idle; and
combining the determined percentages over multiple time periods.

17. The non-transitory computer-readable medium of claim 14, wherein said determining a current busyness comprises:
periodically determining a rate of change in a size of the queue; and
identifying a sequence of successive increases in the size of the queue over multiple time periods.

18. The non-transitory computer-readable medium of claim 14, wherein said determining a current busyness comprises:
periodically determining a rate of change in a size of the queue; and
identifying a sequence of successive decreases in the size of the queue over multiple time periods.

19. The non-transitory computer-readable medium of claim 14, wherein the method further comprises periodically obtaining, for each of the multiple queues:
a number of worker entities currently assigned to the queue; and
a number of tasks within the queue that are currently being processed by the assigned worker entities.

20. The non-transitory computer-readable medium of claim 14, wherein the first busyness threshold and the second busyness threshold are the same.
